(19) United States
(12) Patent Application Publication
(10) Pub. No.: US 2026/0330383 A1
(43) Pub. Date: Oct. 22, 2026

(54) SYSTEMS, APPARATUSES, METHODS, AND COMPUTER PROGRAM PRODUCTS FOR AI DRIVEN PROJECT COMPLIANCE FORECASTING

(71) Applicant: Honeywell International Inc., Charlotte, NC (US)

(72) Inventors: Anil PALLAYIL, Charlotte, NC (US); Rahul SHARMA, Houston, TX (US); Honey RAGHAVAN, Bangalore (IN)

(21) Appl. No.: 19/651,411

(22) Filed: Apr. 17, 2026

Related U.S. Application Data
(60) Provisional application No. 63/790,879, filed on Apr. 18, 2025.

(51) Int. Cl. G06Q 10/0637; G06Q 10/0635; G06Q 10/10

(52) U.S. Cl. CPC G06Q 10/0637; G06Q 10/0635; G06Q 10/103

(57) ABSTRACT

Systems, apparatuses, methods, and computer program products are provided herein. For example, a method may include receiving a project schedule comprising milestone events and a set of dependencies corresponding to the milestone events and analyzing historical projects to identify risks associated with the set of dependencies for the milestone events. The method comprises detecting trigger events corresponding to a subject milestone event of the milestone events, wherein a trigger event of the trigger events corresponds to either a defined deadline or a risk deadline identified according to the historical projects. The method comprises analyzing a current state of a subset of the set of dependencies associated with the subject milestone event and triggering an automated mitigation action responsive to detecting at least one non-compliant dependency associated with the subject milestone event. The method comprises updating project estimations based on the automated mitigation action and the at least one non-compliant dependency.

### CROSS-REFERENCE TO RELATED APPLICATIONS

This application claims priority and benefit to U.S. Provisional Patent Application No. 63/790,879, filed Apr. 18, 2025, the contents of which are incorporated herein by reference it its entirety.

### TECHNOLOGICAL FIELD

Embodiments of the present disclosure relate generally to systems, apparatuses, methods, and computer program products for AI driven project compliance forecasting.

### BACKGROUND

Applicant has identified many technical challenges and difficulties associated with systems, apparatuses, methods, and computer program products for AI driven project compliance forecasting. Through applied effort, ingenuity, and innovation, Applicant has solved problems related to systems, apparatuses, methods, and computer program products for AI driven project compliance forecasting by developing solutions embodied in the present disclosure, which are described in detail below.

### BRIEF SUMMARY

Various embodiments described herein relate to systems, apparatuses, methods, and computer program products for AI driven project compliance forecasting.

In accordance with one aspect of the disclosure a method is provided. In some embodiments, the method comprises receiving a project schedule comprising one or more milestone events and a set of dependencies corresponding to the one or more milestone events. analyzing a set of historical projects to identify one or more risks associated with the set of dependencies for the one or more milestone events. In some embodiments, the method comprises detecting one or more trigger events corresponding to a subject milestone event of the one or more milestone events, wherein a trigger event of the one or more trigger events corresponds to either a defined deadline or a risk deadline identified according to the set of historical projects. In some embodiments, the method comprises analyzing a current state of a subset of the set of dependencies associated with the subject milestone event. In some embodiments, the method comprises triggering an automated mitigation action responsive to detecting at least one non-compliant dependency of the subset of dependencies associated with the subject milestone event. In some embodiments, the method comprises updating one or more project estimations based on the automated mitigation action and the at least one non-compliant dependency.

In accordance with another aspect of the disclosure, an apparatus is provided. In some embodiments, the apparatus includes memory and one or more processors communicatively coupled to the memory. In some embodiments, the one or more processors are configured to perform operations comprising receiving a project schedule comprising one or more milestone events and a set of dependencies corresponding to the one or more milestone events. analyzing a set of historical projects to identify one or more risks associated with the set of dependencies for the one or more milestone events. In some embodiments, the method comprises detecting one or more trigger events corresponding to a subject milestone event of the one or more milestone events, wherein a trigger event of the one or more trigger events corresponds to either a defined deadline or a risk deadline identified according to the set of historical projects. In some embodiments, the method comprises analyzing a current state of a subset of the set of dependencies associated with the subject milestone event. In some embodiments, the method comprises triggering an automated mitigation action responsive to detecting at least one non-compliant dependency of the subset of dependencies associated with the subject milestone event. In some embodiments, the method comprises updating one or more project estimations based on the automated mitigation action and the at least one non-compliant dependency.

In accordance with some aspects of the present disclosure, the apparatus is further configured to analyze the set of historical projects to identify one or more risks associated with the set of dependencies for the one or more milestone events by determining a similarity score associated with a historical project of the set of historical projects and the subject project. Analyzing the set of historical projects may further include identifying one or more missed sub-deadlines associated with the historical project and one or more historical dependencies associated with the one or more missed sub-deadlines responsive to determining that the similarity score exceeds a similarity score threshold. Analyzing the set of historical projects may further include identifying one or more at-risk dependencies of the subject project based on the one or more historical dependencies associated with the one or more missed sub-deadlines.

In accordance with some aspects of the present disclosure, the apparatus is further configured to trigger an automated mitigation action by deploying one or more additional dependencies to carry out one or more functions associated with the at least one non-compliant dependency.

In accordance with some aspects of the present disclosure, the apparatus is further configured to trigger an automated mitigation action by identifying one or more historical mitigation actions taken with respect to the set of historical projects and automatically executing the one or more historical mitigation actions with respect to the subject project.

In accordance with some aspects of the present disclosure, the apparatus is further configured to analyze a current state of a subset of the set of dependencies associated with the subject milestone event by determining an estimate at completion based on the current state of the subset of the set of dependencies associated with the subject milestone event.

In accordance with some aspects of the present disclosure, the apparatus is further configured to trigger an automated mitigation action by altering one or more additional project steps to offset one or more impacts of the non-compliant dependency.

In accordance with some aspects of the present disclosure, the apparatus is further configured to generate a user interface enabling a user to select one or more mitigation actions for execution.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving a project schedule comprising one or more milestone events and a set of dependencies corresponding to the one or more milestone events. analyzing a set of historical projects to identify one or more risks associated with the set of dependencies for the one or more milestone events. In some embodiments, the method comprises detecting one or more trigger events corresponding to a subject milestone event of the one or more milestone events, wherein a trigger event of the one or more trigger events corresponds to either a defined deadline or a risk deadline identified according to the set of historical projects. In some embodiments, the method comprises analyzing a current state of a subset of the set of dependencies associated with the subject milestone event. In some embodiments, the method comprises triggering an automated mitigation action responsive to detecting at least one non-compliant dependency of the subset of dependencies associated with the subject milestone event. In some embodiments, the method comprises updating one or more project estimations based on the automated mitigation action and the at least one non-compliant dependency.

In accordance with some aspects of the disclosure, the computer program code, in execution with at least one processor, configures the computer program product to analyze the set of historical projects to identify one or more risks associated with the set of dependencies for the one or more milestone events by determining a similarity score associated with a historical project of the set of historical projects and the subject project. Analyzing the set of historical projects may further include identifying one or more missed sub-deadlines associated with the historical project and one or more historical dependencies associated with the one or more missed sub-deadlines responsive to determining that the similarity score exceeds a similarity score threshold. Analyzing the set of historical projects may further include identifying one or more at-risk dependencies of the subject project based on the one or more historical dependencies associated with the one or more missed sub-deadlines.

In accordance with some aspects of the disclosure, the computer program code, in execution with at least one processor, configures the computer program product to trigger an automated mitigation action by deploying one or more additional dependencies to carry out one or more functions associated with the at least one non-compliant dependency.

In accordance with some aspects of the disclosure, the computer program code, in execution with at least one processor, configures the computer program product to trigger an automated mitigation action by identifying one or more historical mitigation actions taken with respect to the set of historical projects and automatically executing the one or more historical mitigation actions with respect to the subject project.

In accordance with some aspects of the disclosure, the computer program code, in execution with at least one processor, configures the computer program product to analyze a current state of a subset of the set of dependencies associated with the subject milestone event by determining an estimate at completion based on the current state of the subset of the set of dependencies associated with the subject milestone event.

In accordance with some aspects of the disclosure, the computer program code, in execution with at least one processor, configures the computer program product to trigger an automated mitigation action by altering one or more additional project steps to offset one or more impacts of the non-compliant dependency.

In accordance with some aspects of the disclosure, the computer program code, in execution with at least one processor, configures the computer program product to generate a user interface enabling a user to select one or more mitigation actions for execution.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example timeline in accordance with at least an example embodiment of the present disclosure;

FIG. 5 illustrates an example interface in accordance with at least an example embodiment of the present disclosure; and

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for AI driven project compliance forecasting. As would be understood by one skilled in the field to which this disclosure pertains, there are numerous example scenarios in which systems, apparatuses, methods, and computer program products for AI driven project compliance forecasting.

In project management, project compliance forecasts provide insights regarding a current state of a project, and whether or not the project will meet its current set of estimates (impact value, schedule, etc.). For example, an Estimate at Completion (EAC) forecast is a tool used to predict the total impact value of a project at its completion, considering actual impact values and remaining work. Such tools help to identify potential budget issues, resource allocation needs, and required scheduling updates. Current systems for predicting project compliance fail to adequately monitor current project progress while also failing to trigger automated mitigation actions when a potential delay and/or a change in impact value is detected. Embodiments of the present disclosure enable identification of potential risks based on historical project analysis, while also providing mitigation action triggers responsive to detection of one or more at-risk dependencies. These techniques enable improved project management by minimizing scheduling delays and the impacts of changing impact values by providing automated prompt reactions to adverse project conditions.

Thus, to address these and/or other issues related to such example solutions, example systems, apparatuses, methods, and computer program products for AI driven project compliance forecasting are disclosed herein. For example, an embodiment in this disclosure, described in greater detail below, includes a method that comprises receiving a project schedule comprising one or more milestone events and a set of dependencies corresponding to the one or more milestone events. analyzing a set of historical projects to identify one or more risks associated with the set of dependencies for the one or more milestone events. In some embodiments, the method comprises detecting one or more trigger events corresponding to a subject milestone event of the one or more milestone events, wherein a trigger event of the one or more trigger events corresponds to either a defined deadline or a risk deadline identified according to the set of historical projects. In some embodiments, the method comprises analyzing a current state of a subset of the set of dependencies associated with the subject milestone event. In some embodiments, the method comprises triggering an automated mitigation action responsive to detecting at least one non-compliant dependency of the subset of dependencies associated with the subject milestone event. In some embodiments, the method comprises updating one or more project estimations based on the automated mitigation action and the at least one non-compliant dependency. Accordingly, the systems, apparatuses, methods, and computer program products provided herein leverage historical project information to implement automatic remediation actions proactively reactive to updated project details.

Further embodiments and advantages of the example systems, apparatuses, methods, and computer program products disclosed herein are described in the following co-pending U.S. patent applications: U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,885, titled “SYSTEMS, APPARATUSES, METHODS, AND COMPUTER PROGRAM PRODUCTS FOR REAL-TIME PROJECT SERVICES OPERATIONS”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products configured for AI driven project compliance forecasting. It should be readily appreciated that the embodiments of the apparatus, systems, methods, and computer program product described herein may be configured in various additional and alternative manners in addition to those expressly described herein.

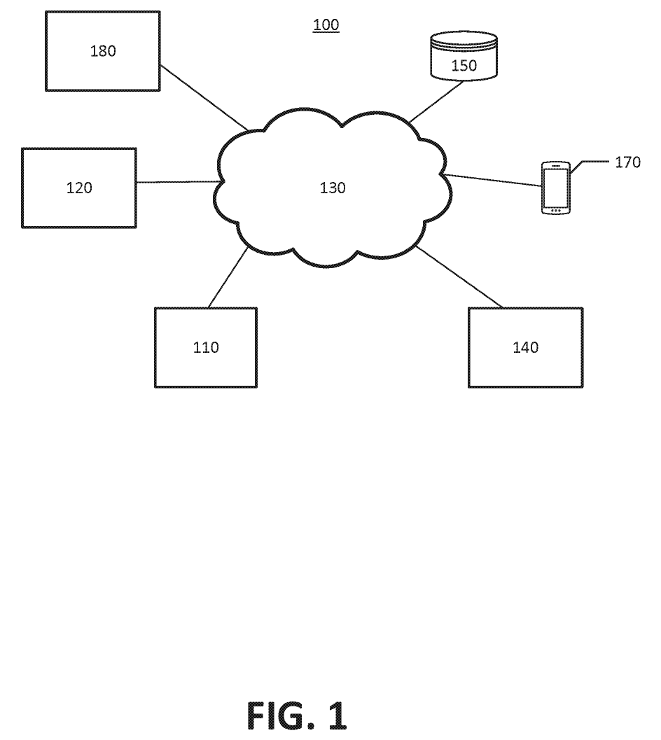

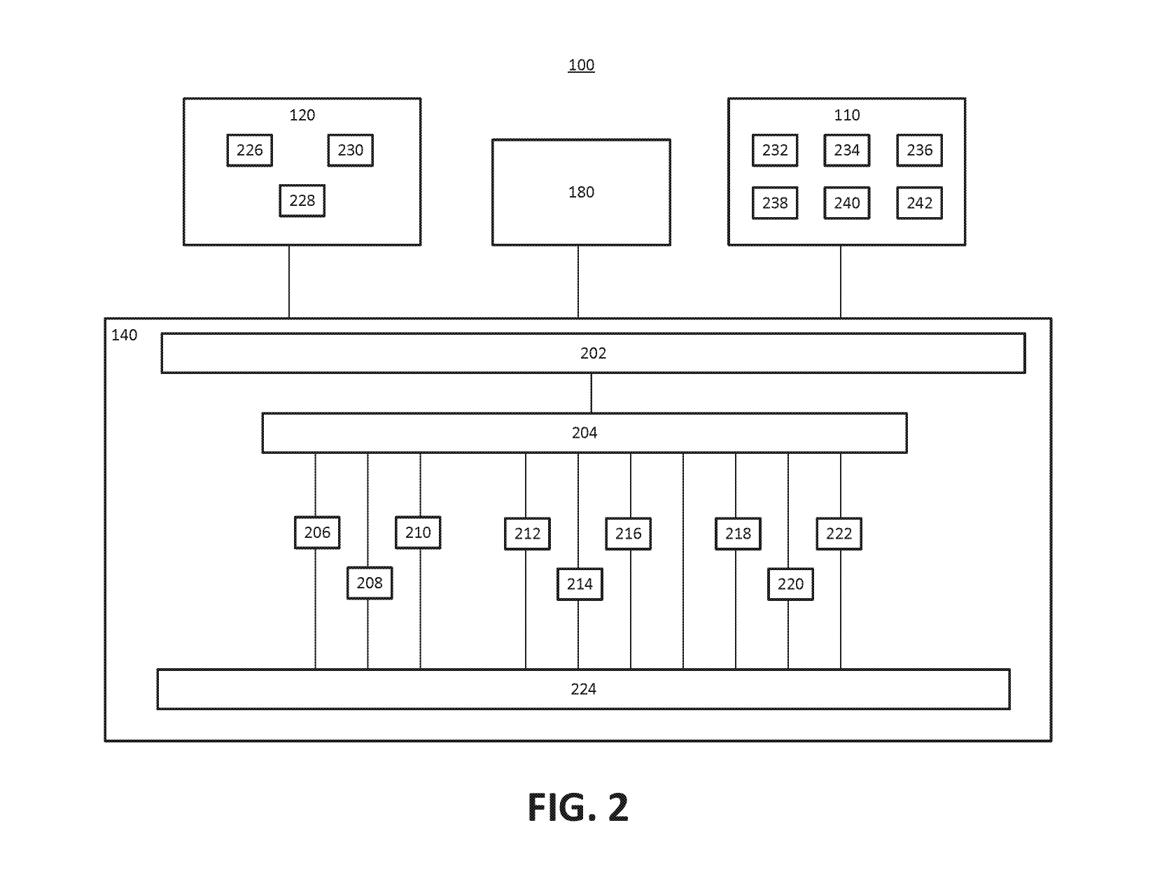

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the external project implementation device 120 comprises one or more external predictive computing entities configured to execute and/or perform one or more operations and/or functions described herein. For example, the external project implementation device 120 may comprise a project extraction predictive computing entity 226, a project code predictive computing entity 228, a project bot predictive computing entity 230, and/or the like.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the external project application device 110 comprises one or more external computing applications configured to execute and/or perform one or more operations and/or functions described herein. For example, THE external project application device 110 may comprise a project operations computing application 232, a project impact value computing application 234, a project documentation computing application 236, a project component computing application 238, a project generation computing application 240, a project automation computing application 242, and/or the like.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

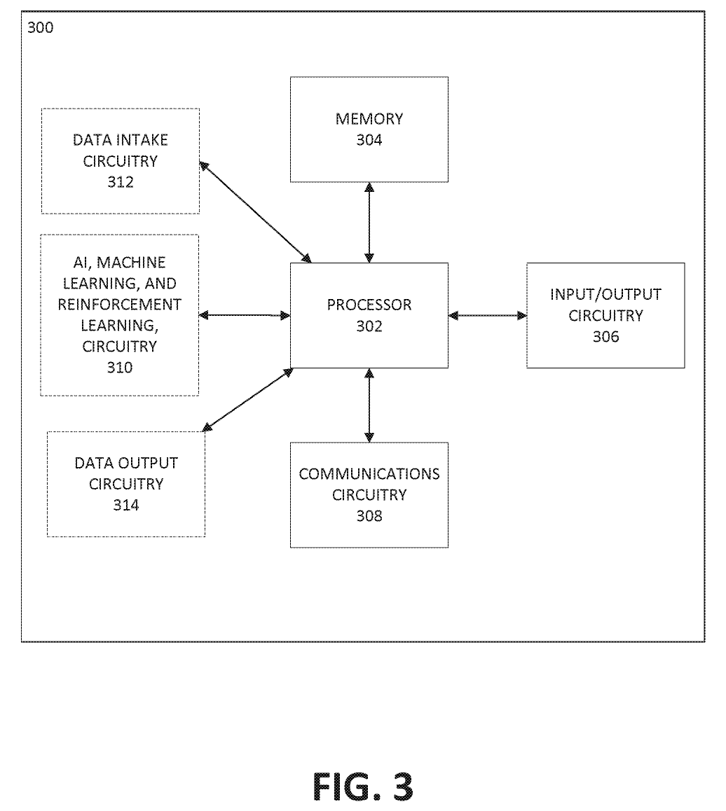

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

With reference to FIGS. 1-6, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of configured components that include temperature sensors, temperature control systems, circuits, and/or heating, ventilation, and air conditioning (HVAC) units that may be implemented in order to control the temperature of a building.

In some embodiments, the cloud-based project operations device 140 is configured to access one or more requirement electronic records. For example, the cloud-based project operations device 140 may be configured to access one or more requirement electronic records at the project orchestration predictive computing entity 204 (e.g., the cloud-based project operations device 140 is configured to access one or more requirement electronic records using the project orchestration predictive computing entity 204).

In some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic record may be a text document that describes one or more requirement features. As another example, a requirement electronic record may be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

In some embodiments, accessing one or more requirement electronic records comprises the cloud-based project operations device 140 being configured to retrieve one or more requirement electronic records. For example, the cloud-based project operations device 140 may be configured to retrieve one or more requirement electronic records from the one or more databases 150 using the project orchestration predictive computing entity 204. As another example, the cloud-based project operations device 140 may be configured to retrieve one or more requirement electronic records from the internal databases 224 using the project orchestration predictive computing entity 204. In some embodiments, accessing one or more requirement electronic records comprises the cloud-based project operations device 140 being configured to receive one or more requirement electronic records. For example, the cloud-based project operations device 140 may be configured to receive one or more requirement electronic records from the project foundation device 180. In some embodiments, prior to the cloud-based project operations device 140 accessing one or more requirement electronic records at the project orchestration predictive computing entity 204, at least one of the one or more requirement electronic records may be processed by the project operations security layer 202 using one or more cybersecurity operations.

In some embodiments, the cloud-based project operations device 140 is configured to identify an archived project electronic record. In some embodiments, an archived project electronic record comprises an electronic record that describes a completed, previous, and/or archived project. In this regard, in some embodiments, an archived project electronic record is representative of a collection of archived project components that were implemented in the completed, previous, and/or archived project associated with the archived project electronic record. For example, an archived project electronic record may be representative of a collection of archived project components that include temperature sensors, temperature control systems, circuits, and/or heating, ventilation, and air conditioning (HVAC) units that have been configured to control the temperature of a building. Said differently, for example, an archived project electronic record may be representative of an archived project component that formed a portion of a completed, previous, and/or archived project.

In some embodiments, the cloud-based project operations device 140 is configured to identify an archived project electronic record using the project record predictive computing entity 212. In some embodiments, the cloud-based project operations device 140, using the project record predictive computing entity 212, is configured to identify an archived project electronic record by performing at least one electronic filtering operation of a set of electronic filtering operations. In some embodiments, the cloud-based project operations device 140, using the project record predictive computing entity 212, is configured to identify an archived project electronic record based on a requirement electronic record. In this regard, in some embodiments, the cloud-based project operations device 140, using the project record predictive computing entity 212, is configured to perform one or more of the set of electronic filtering operations based on a requirement electronic record.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from one or more archived project electronic records using an optical character recognition (OCR) technique. In some embodiments, a text-based filtering operation comprises comparing the first sequence of characters with one or more of the one or more other sequences of characters. In this regard, for example, the cloud-based project operations device 140 may identify an archived project electronic record by finding a match between the first sequence of characters and the one or more of the one or more other sequences of characters. In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique).

In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from one or more archived project electronic records. In some embodiments, a geometry-based filtering operation comprises comparing the geometric element with one or more of the one or more other geometric elements. In this regard, for example, the cloud-based project operations device 140 may identify an archived project electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprise one or more of an svg, .dwg, .tiff, .png, .obj, .amf, .stl, and/or .glb data encoding. In some embodiments, a design-based filtering operation comprises identifying one or more other data encodings from one or more archived project electronic records. In some embodiments, a design-based filtering operation comprises comparing the data encoding with one or more of the one or more other data encodings. In this regard, for example, the cloud-based project operations device 140 may identify an archived project electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from one or more archived project electronic records. In some embodiments, a sketch-based filtering operation comprises comparing the sketch feature with one or more of the one or more other sketch features. In this regard, for example, the cloud-based project operations device 140 may identify an archived project electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from one or more archived project electronic records. In some embodiments, a topology-based filtering operation comprises comparing the topology feature with one or more of the one or more other topology features. In this regard, for example, the cloud-based project operations device 140 may identify an archived project electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from one or more archived project electronic records. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify an archived project electronic record by finding a match between the first pixel data and the other pixel data.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, requirement feature may be representative of a physical layout of a building in which the temperature is to be controlled (e.g., a constraint).

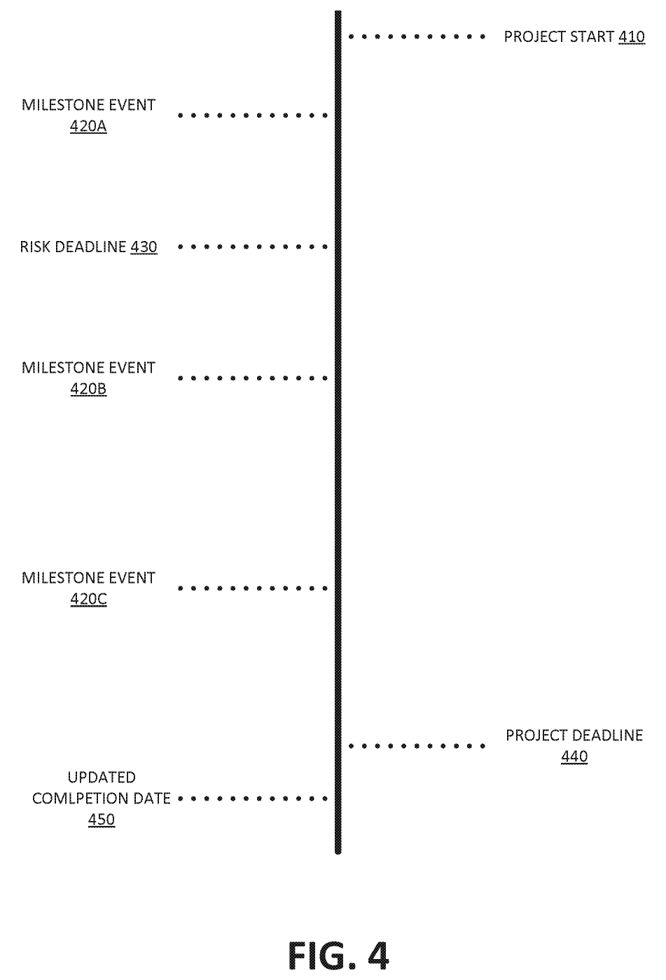

Referring now to FIG. 4, an example timeline 400 is illustrated in accordance with at least some example embodiments of the present invention. As depicted, the example timeline 400 includes a project start 410, a set of milestone events 420, a risk deadline 430, a project deadline 440, and an updated completion date 450. Project defined timing components, such as the project start 410 and the project deadline 440, are displayed on the right side of the example timeline 400, whereas events/sub-deadlines generated by the techniques as described herein are displayed on the left side of the example timeline 400.

As depicted, the example timeline 400 begins with a project start 410, and proceeds to a first milestone event 420A. In at least some example embodiments, a first set of dependencies are configured to complete a first step of the subject project by a determined time associated with milestone event 420A. Similarly, a second set of dependencies (which may or may not be separate from the first set of dependencies) are configured to complete a second step of the subject project by the second milestone event 420B. With respect to the depicted embodiment, the second step of the subject project corresponds to either a risk-associated step or one or more risk-associated dependencies, and as such, the second step of the subject project includes a determined risk deadline 430. Risk deadline 430 may correspond to a time/date by which a certain progress/state should be reached with respect to the second step. For example, if the second step requires creation of 100 units of product, risk deadline 430 may correspond to a time halfway between milestone event 420A and milestone event 420B by which 50 units of product should be created. Risk deadline 430 provides an intermediate time at which project status can be analyzed to determine whether one or more mitigation actions may be required to meet a project deadline/minimize potential delays. In at least some example embodiments, a third set of dependencies (which may or may not be separate from the first set of dependencies and/or the second set of dependencies) are configured to complete a third step of the subject project by the third milestone event 420C. The example timeline 400 proceeds to a project deadline 440, which is a deadline indicated by project information received at the outset of the project. As depicted, the project timeline 400 additionally includes an updated completion date 450. Such an updated completion date 450 may correspond to an updated completion date determined based on one or more mitigation actions implemented responsive to determining the conditions of the risk deadline 430 have not been met, for example.

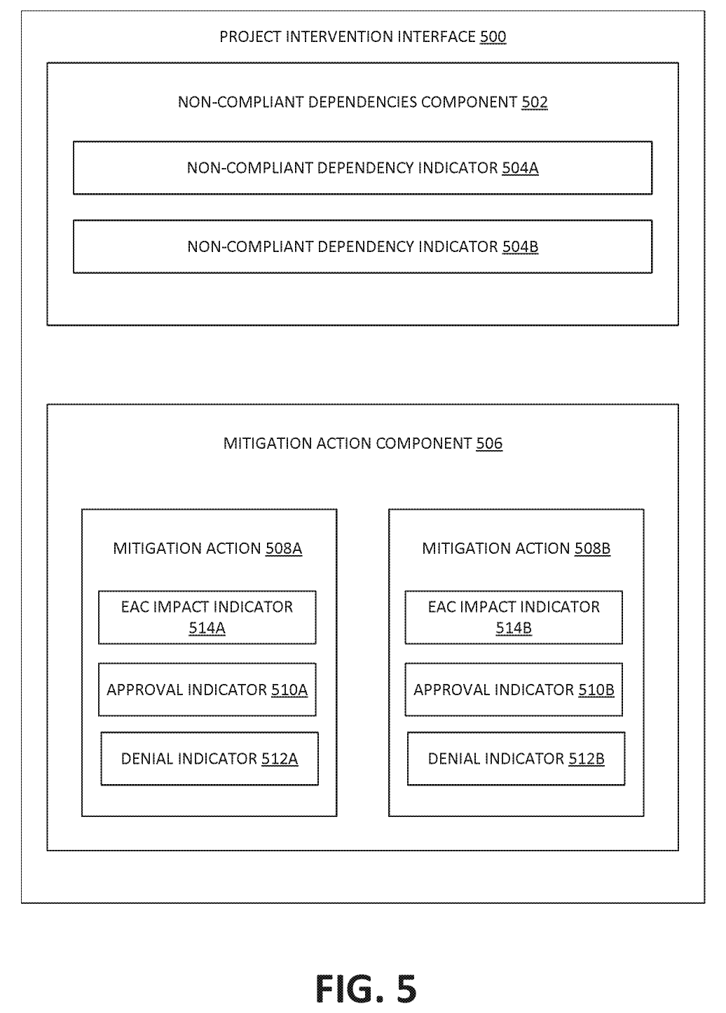

Referring now to FIG. 5, an example project intervention interface 500 is illustrated in accordance with at least some example embodiments of the present invention. As depicted, the project intervention interface 500 includes a non-compliant dependencies component 502 and a mitigation action component 506. Non-compliant dependencies component 502 includes a plurality of selectable non-compliant dependency indicators 504. Each non-compliant dependency indicator is selectable by the user to trigger display of a corresponding mitigation action component 506. As depicted, mitigation action component 506 is configured to display mitigation action indicators 508 corresponding to mitigation actions a user may opt to approve or deny with respect to a selected non-compliant dependency indicator 504 (either non-compliant dependency indicator 504A or non-compliant dependency indicator 504B, with respect to the depicted embodiment. As depicted, each mitigation action indicator 508 (508A, 508B) includes a corresponding approval indicator 510 (510A, 510B) via which a user can approve execution of the corresponding mitigation action. Each mitigation action indicator 508 additionally includes a corresponding denial indicator 512 (512A, 512B) via which a user can deny or block execution of the corresponding mitigation action. Each mitigation action indicator 508 additionally includes an EAC impact indicator 514 (514A, 514B), via which an impact on a subject’s estimate at completion associated with the corresponding mitigation action is displayed for user consideration.

It should be appreciated that, though the example project intervention interface 500 includes one or more components enabling user interactions with mitigation actions, embodiments exist in which the mitigation actions are triggered automatically absent any required user interaction. In yet other embodiments, an appropriate project intervention interface is configured to display the subject mitigation actions and corresponding EAC impact(s) absent interface components enabling user interactions for approving or denying execution of the mitigation actions. Notably, the project intervention interface 500 is applicable in embodiments which enable user overview of mitigation actions prior to execution.

### Example Methods

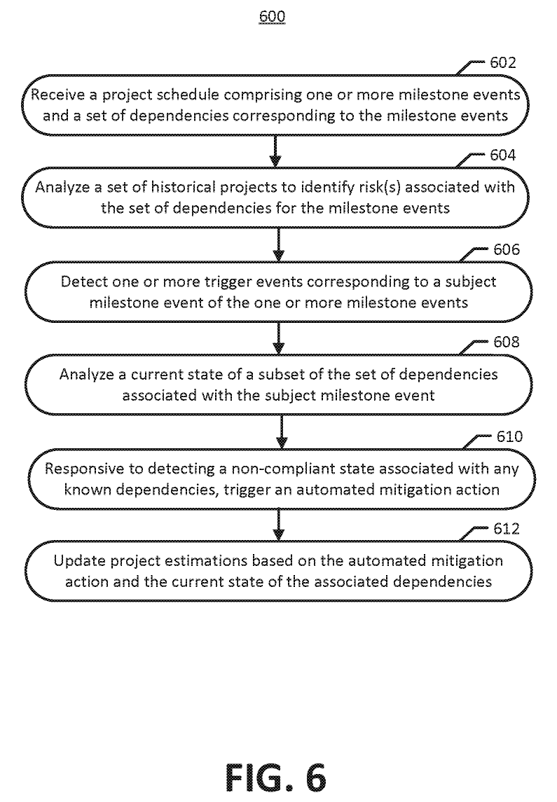

Referring now to FIG. 6, a flowchart providing an example method 600 is illustrated. In this regard, FIG. 6 illustrates operations that may be performed by the project foundation device 180, the external project implementation device 120, the external project application device 110, the cloud-based project operations device 140, the one or more databases 150, and/or the user device 170. In some embodiments, the method 600 comprises operations for forecasting project completion details and ensuring compliance with a project schedule via automated mitigation actions. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As depicted, example method 600 includes receiving a project schedule comprising one or more milestone events and a set of dependencies corresponding to the one or more milestone events, analyzing a set of historical projects to identify one or more risks associated with the set of dependencies for the one or more milestone events, detecting one or more trigger events corresponding to a subject milestone event of the one or more milestone events, wherein a trigger event of the one or more trigger events corresponds to either a defined deadline or a risk deadline identified according to the set of historical projects, analyzing a current state of a subset of the set of dependencies associated with the subject milestone event, responsive to detecting at least one non-compliant dependency of the subset of dependencies associated with the subject milestone event, triggering an automated mitigation action, and updating one or more project estimations based on the automated mitigation action and the at least one non-compliant dependency. Example method 600 may enable determination of an estimate-at-completion and compliance with a project schedule as initially provided.

At step 602, a subject device receives a project schedule and a set of dependencies. Receiving a project schedule comprising one or more milestone events and a set of dependencies corresponding to the one or more milestone events may include receiving a project schedule indicating (i) one or more sub-deadlines which need to be met to ensure the project as a whole meets its projected/required completion date, and (ii) a set of factors associated with each milestone event indicating which project factors/elements contribute to the completion of corresponding tasks for satisfying conditions of said milestone events. In at least some embodiments, the one or more milestone events correspond to the one or more sub-deadlines which need to be met to ensure the project as a whole meets its projected/required completion date. In at least some embodiments, receiving a project schedule includes receiving a document or other record describing project information, such as a set of project requirements, a set of project steps and a subset of the set of dependencies corresponding to each step of the set of project steps. For example, for a subject project step of the set of project steps, the project information may include one or more dependencies (required resources, services, and/or the like) required to complete the subject project step.

In at least some embodiments, such as those wherein the set of project information does not indicate one or more sub-deadlines explicitly, receiving a project schedule may further include analyzing a subject project step to determine an estimated time to complete the subject project step, and establishing sub-deadlines based on the estimated time to complete said subject project step. For example, if a project includes a first step A, a second step B, and a third step C, which must be completed in order, and a completion deadline for the overall project of March 30^{th}, determining a set of sub-deadlines may include determining an estimated completion time (for example, 5 days) for step A, an estimated completion time (for example, 10 days) for step B, and an estimated completion time (for example, 5 days) for step C. Determining the set of sub-deadlines may include determining that, in order to complete the third and final step C, step B must be completed allowing at least 5 days for completion of step C, and as such, the sub-deadline for step B must allow at least 5 days for completion of step C. Therefore, the sub-deadline associated with step B would be determined as March 25^{th}, thereby enabling completion of step C by March 30^{th}. Similarly, to facilitate completion of step B by March 25^{th}, step A must be completed with enough time to allow the 10 days estimated to complete step B prior to the sub-deadline of March 25^{th}, and as such, the sub-deadline associated with step A would be determined as March 15^{th}. In at least some embodiments, a buffer time associated with each estimated completion time may be added by default to accommodate potential delay(s) or inaccuracy associated with the estimated completion time. With respect to the example as described, a buffer time of one (1) day may be added to each estimated completion time such that the sub-deadlines more strictly enable completion of the subject project by the overall project deadline. In at least some embodiments, sub-deadlines associated with overview steps such as approvals of each step or final review prior to project completion may be additionally incorporated into the overall timeline.

At step 604, the subject device analyzes a set of historical projects to identify risks associated with the set of dependencies. In at least some embodiments, analyzing a set of historical projects includes identifying similar historical projects based on the project metadata and the one or more project requirements by analyzing a plurality of projects available via a project database, a historical project database, and/or other source of historical project metadata. In at least some embodiments, identifying one or more similar historical projects comprises determining a similarity score between the one or more project features and one or more historical project features of the one or more similar historical projects. Identifying similar historical projects based on the subject project metadata and the one or more project requirements may include, for a subject historical project of the plurality of historical projects, comparing the determined similarity score to a defined similarity score threshold indicating a level of similarity which much be met for two projects to be considered similar. In at least some embodiments, identifying similar historical projects based on the project metadata and the one or more project requirements includes identifying similar historical projects according to a subset of the one or more project features identified as most pertinent to determining project similarity. In at least some embodiments, one or more features may be weighted more heavily than others when determining project similarity. For example, an authority responsible for issuing a project may be weighted more heavily than other features, as the issuing authority may provide a more applicable subset of potentially pertinent features than other features or categories. In some embodiments, a historical project may be referred to as an archived project.

Analyzing a set of historical projects to identify one or more risks associated with the set of dependencies for the one or more milestone events may include identifying, for one or more historical projects which are found to be substantially similar to the subject project, one or more factors or “risks” which ultimately contributed to delays in said projects/a failure to meet one or more deadlines associated with said projects. In at least some embodiments, analyzing a set of historical projects includes, for one or more historical projects which share a requisite number of pertinent features, requirements, and/or steps, identifying missed deadlines and/or sub-deadlines associated with the historical project. Upon identifying at least one missed sub-deadline associated with the historical project, the subject device may be configured to identify one or more dependencies associated with the at least one missed sub-deadline. In at least some embodiments, the identified one or more dependencies include one or more resources, services, contractors, and/or the like which were responsible for completion of one or more project steps associated with the at least one missed sub-deadline. Analyzing the set of historical projects to identify one or more risks may additionally include identifying risks on the basis of a comparison between a step associated with a missed sub-deadline of the historical project and a step of the subject project. For example, a step of the subject project may be identified as a risk based on a target similarity between the subject project step and the historical project step associated with the missed sub-deadline. Step-based analysis such as this may be beneficial in embodiments wherein the dependency information is not readily available for analysis/comparison.

In at least some embodiments, analyzing the set of historical projects to identify one or more risks associated with the set of dependencies includes associating the identified one or more risks with a subject milestone event which is impacted by the identified risk(s). In at least some embodiments, analyzing the set of historical projects further includes generating one or more risk deadlines according to which step/dependency progress will be measured to determine whether the overall project is at risk. For example, for an identified risk step, the subject device may generate an additional deadline, hereinafter a “risk deadline,” by which an intermediate project state should be reached. For example, if 100 units of a certain product must be produced via a project step associated with an identified risk, the subject device may generate a risk deadline in advance of the corresponding milestone event, wherein the risk deadline indicates a time by which half of the units (50) should be produced in order to keep the project on time.

At step 606, the subject device detects one or more trigger events corresponding to a subject milestone event. Detecting one or more trigger events corresponding to a subject milestone event of the one or more milestone events, wherein a trigger event of the one or more trigger events corresponds to either a defined deadline or a risk deadline identified according to the set of historical projects. A risk deadline may include a time by which a certain dependency should reach a certain state in order to meet the requirements of the subject milestone event. For example, a risk deadline may correspond to a time by which a dependency responsible for production of a required component should be halfway through its production quantity in order to meet the milestone event deadline. A defined deadline may simply be a deadline defined relative to the milestone events of the current project (i.e., 10 days before the event, 8 hours before the event, etc.). In general, the one or more trigger events may correspond to events which may ultimately impact an estimate at completion for one or more project features depending on the outcome of the trigger event.

At step 608, the subject device analyzes a current state of a subset of the set of dependencies associated with the subject milestone event. Analyzing a current state of a subset of the set of dependencies associated with the subject milestone event may include determining whether the subset of dependencies is on track to complete any required tasks by the subject milestone event. For example, in an embodiment wherein the detected trigger event is a risk deadline associated with a production dependency, the subject device may be configured to determine whether said dependency has satisfied a production metric associated with the risk deadline. If the production dependency has indeed satisfied said production metric, the current state of the production dependency may be indicated as “compliant” or “on-track”; if the production dependency has not satisfied the production metric, the current state of the production dependency may be indicated as “non-compliant” or “at risk” or “delayed”. In at least some embodiments, analyzing a current state of the subset of dependencies may include updating one or more estimate at completion metrics associated with a final impact value (e.g., a final cost) or final completion time based on the current state of the subset of the set of dependencies.

At step 610, the subject device triggers an automated mitigation action responsive to detecting at least one non-compliant dependency of the subset of dependencies associated with the subject milestone event. Triggering an automated mitigation action may include triggering a defined action associated with the at least one non-compliant dependency. In some embodiments, one or more mitigation actions may be defined for execution when a non-compliant state is detected at a milestone event. In other embodiments, an AI component may be configured to identify, based on actions taken in the set of historical projects, one or more appropriate actions for mitigating the non-compliant dependency. Such an AI component may be configured to analyze the subsequent outcomes (how long was a project delayed, how was impact value affected, etc.) of each mitigation action reflected by the set of historical projects such that it can select an action which minimizes the impact on the project’s estimate at completion and delays to the schedule. In at least some embodiments, triggering an automated mitigation action includes analyzing one or more historical projects which experienced risk(s) associated with the same, or a substantially similar, non-compliant dependency to identify one or more mitigation actions ultimately taken with respect to said one or more historical projects. In at least some embodiments, triggering an automated mitigation action includes contacting or otherwise deploying an additional dependency, either in addition to the non-compliant dependency or in place of the non-compliant dependency, in an attempt to meet the subject deadline. In at least some embodiments, triggering an automated mitigation action includes identifying and leveraging one or more impact value-saving actions with respect to one or more project steps to offset impact value increases associated with addressing the non-compliant dependency. In at least some embodiments, triggering an automated mitigation includes identifying and leveraging one or more time-saving actions with respect to one or more project steps to offset delays associated with addressing the non-compliant dependency.

In at least some embodiments, triggering an automated mitigation action may include generating a set of mitigation actions according to the above and presenting said mitigation actions to a user via an interface. In such embodiments, the interface may be configured to display one or more mitigation actions to a user, thereby enabling the user to select/approve a mitigation action. In embodiments wherein a plurality of mitigation actions is generated or available for addressing the non-compliant dependency, presenting said mitigation actions to the user includes generating an interface comprising a plurality of selectable interface components via which a user can select one of the mitigation actions for execution. In at least some embodiments, such an interface may include an option to decline executing any mitigation actions. In at least some embodiments, such an interface includes, with respect to each mitigation action, an estimated impact on one or more project details, such as impact value, completion time, deadline status, and the like. In at least some embodiments, such an interface may include an open text prompt via which the user can enter one or more natural language queries, via a text input device or a voice input device, for example, regarding the subject mitigation actions and associated project outcomes. It should be appreciated that, though mechanisms are described by which a user is enabled to select or otherwise interact with the one or more mitigation actions, many embodiments exist in which one or more mitigation actions are automatically triggered, either based on determining which mitigation action yields the least impact with respect to the project outcomes, or based on a defined preference profile for determining a preferred mitigation action.

At step 612, the subject device updates project estimations based on the automated mitigation action and the at least one non-compliant dependency. Updating one or more project estimations based on the automated mitigation action and the at least one non-compliant dependency may include analyzing the set of historical projects to identify one or more mitigation action impacts associated with historical implementations of similar actions and predicting impacts associated with the current project based on said analysis. In at least some embodiments, updating one or more project estimations may include updating an impact value estimate (e.g., a cost estimate) and/or a scheduling estimate associated with the project based on a selected/implemented automated mitigation action.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A computer-implemented method comprising:
receiving, by one or more processors and for a subject project, a project schedule comprising one or more milestone events and a set of dependencies corresponding to the one or more milestone events;
analyzing, by the one or more processors, a set of historical projects to identify one or more risks associated with the set of dependencies for the one or more milestone events;
detecting, by the one or more processors, one or more trigger events corresponding to a subject milestone event of the one or more milestone events, wherein a trigger event of the one or more trigger events corresponds to either a defined deadline or a risk deadline identified according to the set of historical projects;
analyzing, by the one or more processors, a current state of a subset of the set of dependencies associated with the subject milestone event;
responsive to detecting at least one non-compliant dependency of the subset of the set of dependencies associated with the subject milestone event, triggering, by the one or more processors, an automated mitigation action; and
updating, by the one or more processors, one or more project estimations based on the automated mitigation action and the at least one non-compliant dependency.

2. The computer-implemented method of claim 1, wherein analyzing the set of historical projects to identify one or more risks associated with the set of dependencies for the one or more milestone events comprises:
determining a similarity score associated with a historical project of the set of historical projects and the subject project;
responsive to determining that the similarity score exceeds a similarity score threshold, identifying one or more missed sub-deadlines associated with the historical project and one or more historical dependencies associated with the one or more missed sub-deadlines; and
identifying one or more at-risk dependencies of the subject project based on the one or more historical dependencies associated with the one or more missed sub-deadlines.

3. The computer-implemented method of claim 1, wherein triggering an automated mitigation action comprises:
deploying one or more additional dependencies to carry out one or more functions associated with the at least one non-compliant dependency.

4. The computer-implemented method of claim 1, wherein triggering an automated mitigation action comprises:
identifying one or more historical mitigation actions taken with respect to the set of historical projects; and
automatically executing the one or more historical mitigation actions with respect to the subject project.

5. The computer-implemented method of claim 1, wherein analyzing a current state of a subset of the set of dependencies associated with the subject milestone event comprises:
determining an estimate at completion based on the current state of the subset of the set of dependencies associated with the subject milestone event.

6. The computer-implemented method of claim 1, wherein triggering an automated mitigation action comprises:
altering one or more additional project steps to offset one or more impacts of the at least one non-compliant dependency.

7. The computer-implemented method of claim 1, further comprising:
generating, by the one or more processors, a user interface enabling a user to select one or more mitigation actions for execution.

8. An apparatus comprising memory and one or more processors communicatively coupled to the memory, the one or more processors configured to perform operations comprising:
receiving a project schedule comprising one or more milestone events and a set of dependencies corresponding to the one or more milestone events for a subject project;
analyzing a set of historical projects to identify one or more risks associated with the set of dependencies for the one or more milestone events;
detecting one or more trigger events corresponding to a subject milestone event of the one or more milestone events, wherein a trigger event of the one or more trigger events corresponds to either a defined deadline or a risk deadline identified according to the set of historical projects;
analyzing a current state of a subset of the set of dependencies associated with the subject milestone event;
responsive to detecting at least one non-compliant dependency of the subset of the set of dependencies associated with the subject milestone event, triggering an automated mitigation action; and
updating one or more project estimations based on the automated mitigation action and the at least one non-compliant dependency.

9. The apparatus of claim 8, wherein analyzing the set of historical projects to identify one or more risks associated with the set of dependencies for the one or more milestone events comprises:
determining a similarity score associated with a historical project of the set of historical projects and the subject project;
responsive to determining that the similarity score exceeds a similarity score threshold, identifying one or more missed sub-deadlines associated with the historical project and one or more historical dependencies associated with the one or more missed sub-deadlines; and
identifying one or more at-risk dependencies of the subject project based on the one or more historical dependencies associated with the one or more missed sub-deadlines.

10. The apparatus of claim 8, wherein triggering an automated mitigation action comprises:
deploying one or more additional dependencies to carry out one or more functions associated with the at least one non-compliant dependency.

11. The apparatus of claim 8, wherein triggering an automated mitigation action comprises:
identifying one or more historical mitigation actions taken with respect to the set of historical projects; and
automatically executing the one or more historical mitigation actions with respect to the subject project.

12. The apparatus of claim 8, wherein analyzing a current state of a subset of the set of dependencies associated with the subject milestone event comprises:
determining an estimate at completion based on the current state of the subset of the set of dependencies associated with the subject milestone event.

13. The apparatus of claim 8, wherein triggering an automated mitigation action comprises:
altering one or more additional project steps to offset one or more impacts of the at least one non-compliant dependency.

14. The apparatus of claim 8, the operations further comprising:
generating a user interface enabling a user to select one or more mitigation actions for execution.

15. A computer program product comprising at least one non-transitory computer-readable storage medium having computer program code stored thereon that, in execution with at least one processor, configures the computer program product for:
receiving a project schedule comprising one or more milestone events and a set of dependencies corresponding to the one or more milestone events for a subject project;
analyzing a set of historical projects to identify one or more risks associated with the set of dependencies for the one or more milestone events;
detecting one or more trigger events corresponding to a subject milestone event of the one or more milestone events, wherein a trigger event of the one or more trigger events corresponds to either a defined deadline or a risk deadline identified according to the set of historical projects;
analyzing a current state of a subset of the set of dependencies associated with the subject milestone event;
responsive to detecting at least one non-compliant dependency of the subset of the set of dependencies associated with the subject milestone event, triggering an automated mitigation action; and
updating one or more project estimations based on the automated mitigation action and the at least one non-compliant dependency.

16. The computer program product of claim 15, wherein analyzing the set of historical projects to identify one or more risks associated with the set of dependencies for the one or more milestone events comprises:
determining a similarity score associated with a historical project of the set of historical projects and the subject project;
responsive to determining that the similarity score exceeds a similarity score threshold, identifying one or more missed sub-deadlines associated with the historical project and one or more historical dependencies associated with the one or more missed sub-deadlines; and
identifying one or more at-risk dependencies of the subject project based on the one or more historical dependencies associated with the one or more missed sub-deadlines.

17. The computer program product of claim 15, wherein triggering an automated mitigation action comprises:
deploying one or more additional dependencies to carry out one or more functions associated with the at least one non-compliant dependency.

18. The computer program product of claim 15, wherein triggering an automated mitigation action comprises:
identifying one or more historical mitigation actions taken with respect to the set of historical projects; and
automatically executing the one or more historical mitigation actions with respect to the subject project.

19. The computer program product of claim 15, wherein triggering an automated mitigation action comprises:
altering one or more additional project steps to offset one or more impacts of the at least one non-compliant dependency.

20. The computer program product of claim 15, the at least one non-transitory computer-readable storage medium having computer program code stored thereon that, in execution with at least one processor, further configures the computer program product for:
generating a user interface enabling a user to select one or more mitigation actions for execution.
